(19) United States
(12) Patent Application Publication
(10) Pub. No.: US 2026/0228475 A1
(43) Pub. Date: Aug. 6, 2026

(54) IMAGE FORMING APPARATUS

(71) Applicant: FUJIFILM Business Innovation Corp., Tokyo (JP)

(72) Inventor: Miyu FUJII, Kanagawa (JP)

(73) Assignee: FUJIFILM Business Innovation Corp., Tokyo (JP)

(21) Appl. No.: 19/298,285

(22) Filed: Aug. 13, 2025

(30) Foreign Application Priority Data
Jan. 31, 2025 (JP) 2025-014741

(51) Int. Cl. G06K 15/02

(52) U.S. Cl. CPC G06K 15/027

(57) ABSTRACT

An image forming apparatus includes a processor configured to acquire sheet color information that is information on a color tone of a sheet; acquire image information that is information on an image to be formed on the sheet; and acquire mark information that is information on a mark indicating a position of the sheet, in which a process of improving a visibility of the mark in accordance with the sheet color information is performed on an overlap between the image information and the mark, the overlap being acquired from the image information and the mark information.

### CROSS-REFERENCE TO RELATED APPLICATIONS

This application is based on and claims priority under 35 USC 119 from Japanese Patent Application No. 2025-014741 filed January 31, 2025.

### BACKGROUND

### Technical Field

The present invention relates to an image forming apparatus.

### Related Art

Japanese Unexamined Patent Application Publication No. 2012-135899 has disclosed a configuration in which the overlap between an outputted image and a trim mark is subjected to an emphasis process to facilitate the work of cutting.

### SUMMARY

For smooth processing or alignment of sheets, marks indicating positions of the sheets may occasionally be formed on the sheets. In a case where an area for forming such a mark overlaps an image formed on a sheet, a so-called white border, which means not being colored, is formed on a portion of the image that is at the edge of the mark, so that the mark is made more visible regardless of the background image. However, depending on the color of the sheet, the effect of making the mark more visible with the white border may be insufficient.

Aspects of non-limiting embodiments of the present disclosure relate to making a mark more visible even in a case where the visibility of the mark is degraded because of the color tone of the sheet.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including a processor configured to: acquire sheet color information that is information on a color tone of a sheet; acquire image information that is information on an image to be formed on the sheet; and acquire mark information that is information on a mark indicating a position of the sheet, in which a process of improving a visibility of the mark in accordance with the sheet color information is performed on an overlap between the image information and the mark, the overlap being acquired from the image information and the mark information.

### BRIEF DESCRIPTION OF THE DRAWINGS

Exemplary embodiments of the present disclosure will be described in detail based on the following figures, wherein:

FIG. 1 illustrates a configuration of an image forming apparatus;

FIG. 2 illustrates a hardware configuration of a controller and a sensor;

FIG. 3 is a functional block diagram of the controller;

FIG. 4 is a flowchart illustrating a process of forming a mark;

FIGS. 5A and 5B illustrate a process of improving the visibility of the mark in respective cases of sheets each having a margin for forming the mark;

FIGS. 6A to 6C illustrate a process that is performed on a mark or the periphery of the mark in respective cases of sheets each having no margin for forming the mark; and

FIGS. 7A and 7B illustrate a process that is performed on a mark or the periphery of the mark in respective cases of sheets having colors similar to each other and each having no margin for forming the mark.

### DETAILED DESCRIPTION

### Image Forming Apparatus

Exemplary embodiments of the present invention will now be described in detail with reference to the accompanying drawings.

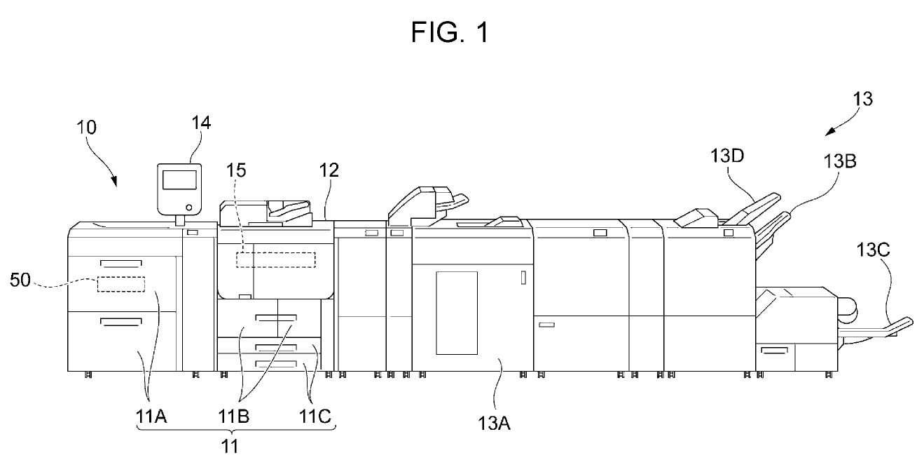

FIG. 1 illustrates a configuration of an image forming apparatus 10.

The image forming apparatus 10 is configured to print an image on a sheet in accordance with a print instruction acquired through, for example, an input made by a user. The term "print instruction" used herein refers to an image to be printed and includes information on the number of pages. The print instruction may further include information on the number of copies, and/or an instruction to execute printing.

The image forming apparatus 10 is, for example, a so-called production printer intended for industrial printing, and has a function of performing a high-speed printing process with high image quality. The image forming apparatus 10 further has a function of performing post-processing on an image-printed sheet in response to a print instruction. Examples of "post-processing" referred to herein include binding of a batch of sheets, folding of a sheet, cutting of a sheet, and bookbinding. Such operations of post-processing are performed with reference to a mark indicating a position of the sheet. In the present exemplary embodiment, the mark is mainly used in performing a process of cutting the sheet. The mark is formed when, for example, an image is printed on a sheet. The mark is not limited to a mark intended for post-processing and may be a mark intended to identify the center position of the sheet.

The image forming apparatus 10 is not limited to a production printer and may be applied to a general printer (e.g., a business printer or a home printer).

The image forming apparatus 10 includes a sheet feeding unit 11 configured to feed a sheet to be printed, a printing unit 12 configured to perform printing on a sheet fed from the sheet feeding unit 11, multiple discharge destinations 13 to which printed sheets are to be discharged, an operation display 14 provided for the user, and a controller 15 configured to control the units included in the image forming apparatus 10.

The sheet feeding unit 11 includes multiple sheet feeding trays 11A, 11B, and 11C configured to feed sheets therefrom. The sheet feeding trays 11A to 11C are capable of feeding sheets of different sizes or the same size.

The sheet feeding unit 11 is provided with a sensor 50 configured to detect sheet color information, which is information on the color tone of the sheet. For example, the sensor 50 measures light reflected from the sheet and thus detects sheet color information. Examples of sheet color information include information such as hue, which indicates the difference in sheet color; lightness, which indicates the brightness of sheet color; and saturation, which indicates the vividness of sheet color. The sensor 50 is configured to output the detected sheet color information to the controller 15 of the image forming apparatus 10. The sensor 50 provided to the sheet feeding tray 11A may alternatively be provided to either of the sheet feeding trays 11B and 11C.

The printing unit 12 employs an electrophotographic scheme in which toner adhered to a photoconductor that has undergone charging and exposure is transferred to a recording material to form an image. The printing unit 12 is configured to form an image by using not only toners of yellow (Y), magenta (M), cyan (C), and black (K) and also toners of special colors such as white and silver. Alternatively to the electrophotographic scheme, for example, an inkjet scheme may be employed in which an image is formed by ejecting ink onto a recording material.

The multiple discharge destinations 13 include a stacker tray 13A, a finisher tray 13B, a finisher discharge tray 13C, and a discharge tray 13D. Transport paths for printed sheets are switchable by a drive source in accordance with print instructions, so that any one of the trays 13A to 13D is to be selected. Thus, continuous printing is enabled. The transport paths are constituted by transport rolls, guide plates, and so forth (not illustrated).

The stacker tray 13A as one of the discharge destinations 13 is provided with a unit configured to perform post-processing in which printed sheets are cut into pieces of a standard size such as A4 size.

The operation display 14 includes a display part configured to display various images relevant to operations and various kinds of information to be communicated to the user, and an input part including various buttons through which inputs are to be made in accordance with operation images provided on the display part. The operation display 14 may have, for example, a touch panel as a display screen so that the functions of both the display part and the input part are provided as the touch panel.

In addition to the function of printing an image on a sheet, the image forming apparatus 10 according to the present exemplary embodiment has a function of optically reading an image of a document or the like and a function of feeding a document page by page to a reading area. The functions listed herein for the image forming apparatus 10 are merely examples, and the image forming apparatus 10 may have other functions.

The image forming apparatus 10 is configured to acquire image information transmitted from a personal computer (PC) or the like (not illustrated). The image information is information on an image to be formed on a sheet and includes information indicating a position or area of the sheet where the image is to be formed. The image information may be acquired by using a function of a printing device that is intended to optically read an image of a document or the like.

### Hardware Configuration

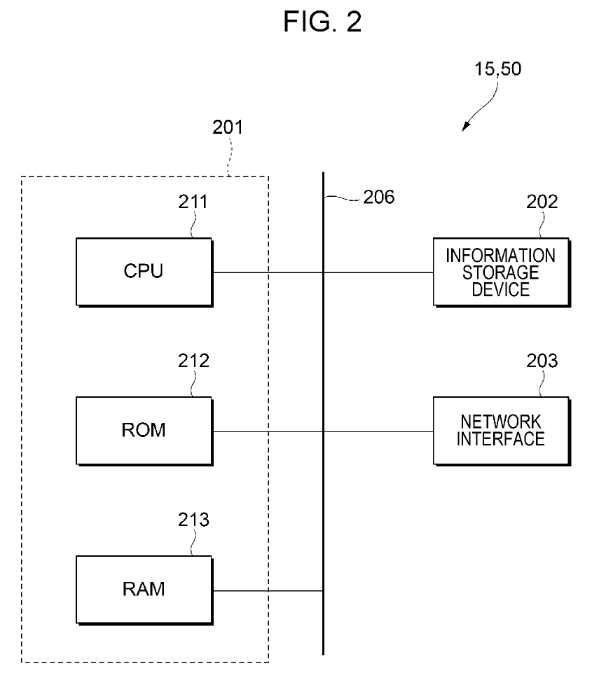

FIG. 2 illustrates a hardware configuration of the controller 15 and the sensor 50. As illustrated in FIG. 2, a computer that implements the controller 15 and the sensor 50 includes a processing unit 201 configured to execute digital arithmetic processing in accordance with a program. The computer that implements the controller 15 and the sensor 50 further includes an information storage device 202 configured to store information. The computer that implements the controller 15 and the sensor 50 further includes a network interface 203 configured to implement communication through a local-area-network (LAN) cable or the like.

The processing unit 201 is constituted by a computer. The processing unit 201 includes a central processing unit (CPU) 211 that is an exemplary processor configured to execute various processing operations. The processing unit 201 further includes a read-only memory (ROM) 212 in which programs are stored, and a random access memory (RAM) 213 to be used as a work area. The information storage device 202 is implemented by an existing device such as a hard disk drive, semiconductor memory, or magnetic tape. The processing unit 201, the information storage device 202, and the network interface 203 are connected to each other with a bus 206 and signal lines (not illustrated).

Programs to be executed by the CPU 211 may be provided to the controller 15 in a form stored in any of computer-readable recording media such as magnetic recording media (e.g., magnetic tapes and magnetic disks), optical recording media (e.g., optical disks), magneto-optical recording media, and semiconductor memories. Programs to be executed by the CPU 211 may be provided to the controller 15 through communication means such as the Internet.

In the present exemplary embodiment, processing operations are to be executed by any computer. The computer may execute the processing operations by using a processor, which is hardware; a program, which is software; or a combination of a processor and a program. In such a case, the processor may cooperate with the program to execute the processing operations according to the present exemplary embodiment, and may function as a unit or means according to the exemplary embodiment. The order in which the processor executes the processing operations is not limited to the one described above and may be changed appropriately. The computer may be a general-purpose computer, an application-specific computer, a workstation, or any other system capable of executing the processing operations.

The processor may be constituted by one or more pieces of hardware, and the kind of the hardware is not limited. For example, the hardware constituting the processor may be any of the following: a central processing unit (CPU), a micro processing unit (MPU), a programmable logic device such as a field-programmable gate array (FPGA), a dedicated circuit for executing a specific processing operation such as an application-specific integrated circuit (ASIC), a graphics processing unit (GPU), and a neural processing unit (NPU). The hardware may be a combination of different kinds of hardware. If multiple pieces of hardware are configured to execute one or more processing operations assigned to the processor, the multiple pieces of hardware may be provided in apparatuses physically separate from each other or may be provided in a single apparatus. In any of such exemplary embodiments, the order in which the processor executes the processing operations is not limited to the one described above and may be changed appropriately. The hardware is constituted by electric circuitry in which circuit elements such as semiconductor devices are combined together, or the like.

The program may be software such as firmware or microcode. The program may be, for example, a program module group. The functions of the program may be implemented by processors configured to implement the respective functions. The program may be program code or multiple code segments stored in one or more non-transitory computer-readable media (for example, storage media or any other storages). The program may be divided to be stored in multiple non-transitory computer-readable media that are provided in apparatuses physically separate from each other. The program code or code segments may represent a procedure, a function, a subprogram, a routine, a subroutine, a module, a software package, a class, or any combination of instructions, data structures, or program statements. The program code or code segments may be connected to another code segment or a hardware circuit through communication of information, data, arguments, parameters, or memory content.

### Functional Configuration of Controller

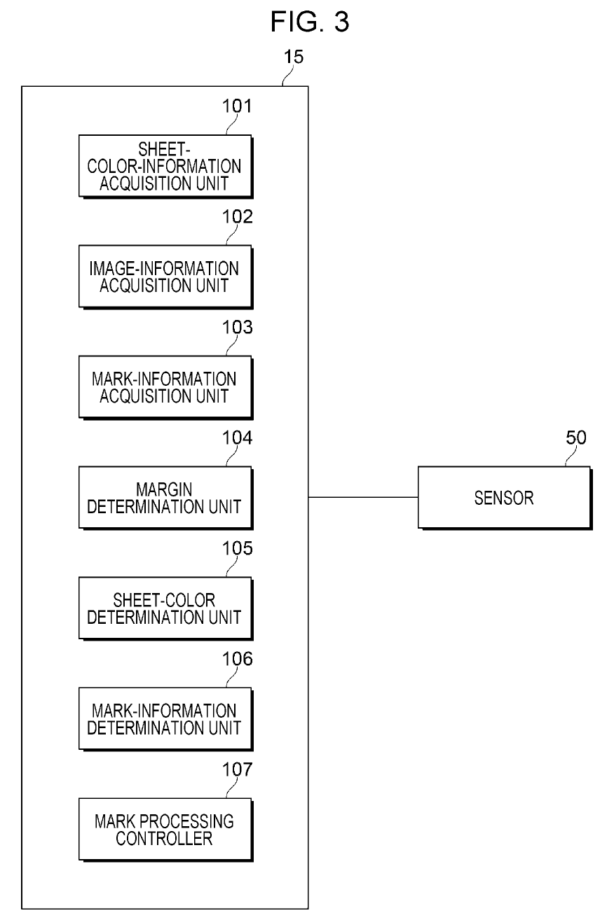

FIG. 3 is a block diagram of functions implemented by the controller 15. The controller 15 includes a sheet-color-information acquisition unit 101 configured to acquire sheet color information from the sensor 50. The controller 15 further includes an image-information acquisition unit 102 configured to acquire image information from a PC or the like. The controller 15 further includes a mark-information acquisition unit 103 configured to generate and acquire information on a mark (hereinafter also referred to as mark information) indicating a position of the sheet at which a process is to be performed. Alternatively to acquiring sheet color information from the sensor 50, the sheet-color-information acquisition unit 101 may acquire sheet color information from, for example, sheet information that is inputted by the user through the operation display 14.

The controller 15 further includes a margin determination unit 104 configured to determine, from the image information and the mark information, whether the sheet has a margin in an area for forming the mark. The controller 15 further includes a sheet-color determination unit 105 configured to determine, from the sheet color information, whether a value related to the color tone of the sheet is lower than a predetermined value. The controller 15 further includes a mark-information determination unit 106 configured to determine, from the mark information, the color of the mark to be formed. The controller 15 further includes a mark processing controller 107 configured to control the printing unit 12 to execute a process of improving the visibility of the mark, in accordance with the results of determinations made by the margin determination unit 104, the sheet-color determination unit 105, and the mark-information determination unit 106.

The information on the mark that is acquired by the mark-information acquisition unit 103 includes the shape of the mark. In the present exemplary embodiment, the mark is an image mainly serving as a guide for performing post-processing such as cutting of the sheet, and is an image that is typically formed at each of the four corners of the sheet. The mark is constituted by a linear image indicating a cutting position, and a linear image indicating a bleed position. The information on the mark that is acquired by the mark-information acquisition unit 103 further includes information on the color tone of an image forming the mark. The color tone of an image forming the mark refers to the color tone defined by lightness, saturation, and hue in a so-called L*a*b* color space.

The margin determination unit 104 is configured to determine a margin from an image-information area of the sheet that is acquired from the image information and a mark area of the sheet that is acquired from the mark information. The image-information area refers to an area of the sheet in which an image, excluding the mark, is to be formed. The mark area refers to an area in which an image is to be formed as a reference for performing post-processing such as cutting of the sheet. According to the present exemplary embodiment, the mark area is mainly constituted by a linear area indicating a cutting position and a linear area indicating a bleed position. The mark area may include an area adjoining the mark.

If there is an overlap between the image-information area and the mark area, the margin determination unit 104 determines that the sheet has no margin for forming a mark. If there is no overlap between the image-information area and the mark area, the margin determination unit 104 determines that the sheet has a margin for forming a mark.

The value related to the color tone of the sheet that is used by the sheet-color determination unit 105 in making determination refers to a lightness value that indicates the degree of color lightness in the so-called L*a*b* color space. A situation where the lightness is higher than or equal to the predetermined value may be expressed as a situation where "the sheet color is light". A situation where the lightness is lower than the predetermined value may be expressed as a situation where "the sheet color is dark". The value related to the color tone of the sheet is not limited to the value of lightness and may be the value of saturation or hue, or a combination of any of lightness, saturation, and hue. The sheet color is not limited to a single color per sheet. A single sheet may have multiple sheet colors.

In the process of improving the visibility of the mark that is executed by the mark processing controller 107, the mark or the periphery of the mark is processed. Herein, the term "visibility" refers to, for example, an index for the user or the like to distinguish between a mark and any object other than the mark. The object other than the mark is the sheet or an image formed on the sheet. Improving the visibility refers to, for example, enabling the user or the like to easily distinguish a mark from any object other than the mark by differentiating the color tone between the mark and the object other than the mark. While the expression "differentiating the color tone" used herein basically refers to "differentiating the lightness", hue or saturation may be differentiated.

With the process of improving the visibility that is executed by the mark processing controller 107, the mark is emphasized so that the sheet and the mark are distinguishable from each other. If a single sheet has multiple sheet colors, different processes for emphasizing the mark may be performed on different areas having respective sheet colors in accordance with the sheet colors. While cases described in the present exemplary embodiment include a case where the process to be performed on the periphery of the mark is not for the entirety of an area adjoining the mark but only a portion of the area, the process may be performed over the entirety of the area adjoining the mark.

### Process of Forming Mark

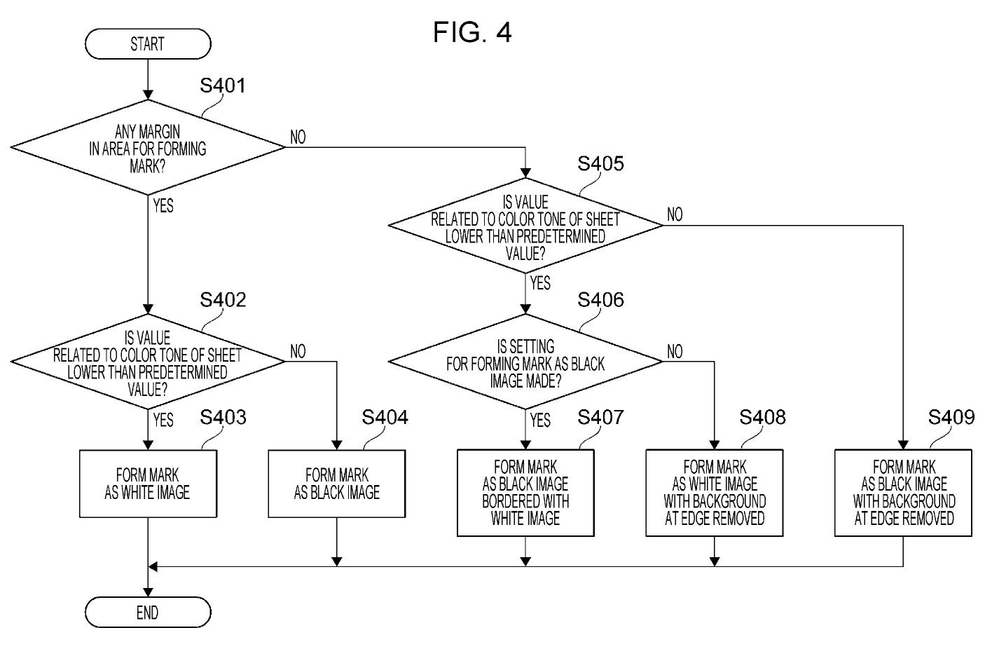

FIG. 4 is a flowchart illustrating a process of forming a mark. First, the margin determination unit 104 checks whether a sheet to be subjected to the process of forming a mark has a margin in an area for forming a mark (step 401). This step is to determine whether the process of improving the visibility of the mark is to be performed on the periphery of the mark. Subsequently, if the sheet has a margin in the area for forming a mark (YES in step 401), the sheet-color determination unit 105 further checks whether the value related to the color tone of the sheet that is acquired from the sheet color information is lower than a predetermined value (step 402). If the value related to the color tone of the sheet is lower than the predetermined value (YES in step 402), the mark processing controller 107 controls the printing unit 12 to execute a process of forming a mark as a white image (step 403). If the value related to the color tone of the sheet is higher than or equal to the predetermined value (NO in step 402), the mark processing controller 107 controls the printing unit 12 to execute a process of forming a mark as a black image (step 404).

If the sheet does not have a margin in the area for forming a mark (NO in step 401), the sheet-color determination unit 105 checks whether the value related to the color tone of the sheet is lower than the predetermined value (step 405). This step is to determine whether the process of improving the visibility of the mark is to be performed as a process using a white image. If the value related to the color tone of the sheet is lower than the predetermined value (YES in step 405), it is further checked whether a setting for forming the mark as a black image is made (step 406). This step is for a dark sheet and to determine, in accordance with the color of the mark, what kind of emphasis process is to be performed on the periphery of the mark. If the setting for forming the mark as a black image is made, the operation is controlled such that a mark as a black image is formed while being bordered with a white image (step 407). Forming a mark as a black image bordered with a white image refers to a process of forming a white image over an area for forming the mark and the periphery of the area, and then forming the mark as a black image.

If the setting for forming the mark as a black image is not made, the operation is controlled such that a mark as a white image is formed while the background at the edge of the mark is removed (step 408). Herein, the edge refers to the periphery of the mark. Furthermore, removing the background at the edge of the mark refers to a process in which the formation of image information is withheld on the area for forming the mark and on the periphery of the area. If the value related to the color tone of the sheet is higher than or equal to the predetermined value (NO in step 405), the operation is controlled such that a mark as a black image is formed while the background at the edge of the mark is removed (step 409).

### Details of Process for Mark

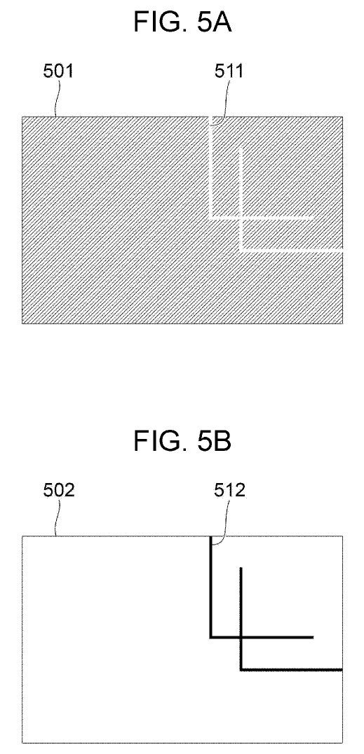

FIGS. 5A and 5B illustrate a process of improving the visibility of the mark in respective cases of sheets each having a margin for forming the mark. FIG. 5A illustrates a process to be performed on the mark in a case of a black sheet 501. FIG. 5B illustrates a process to be performed on the mark in a case of a white sheet 502.

Herein, the black sheet 501 refers to a sheet whose color tone is black. The black sheet 501 is not limited to a sheet having a pure black color and may be any sheet having a color tone that is regarded as black in appearance by the user or the like. For example, the black sheet 501 may be a partially glossy sheet such as miranda paper. The white sheet 502 refers to a sheet whose color tone is white. The white sheet 501 is not limited to a sheet having a pure white color and may be any sheet having a color tone that is regarded as white in appearance by the user or the like. For example, the white sheet 502 may have a yellowish white color such as ivory.

The black sheet 501 and the white sheet 502 have respective color tones that are greatly different from each other mainly in lightness and hue but are similar to each other in saturation. That is, the difference between the black sheet 501 and the white sheet 502 is greater in lightness or hue than in saturation. Black refers to a color represented by a value related to the color tone of the sheet that is lower than a predetermined value. White refers to a color represented by a value related to the color tone of the sheet that is higher than or equal to the predetermined value.

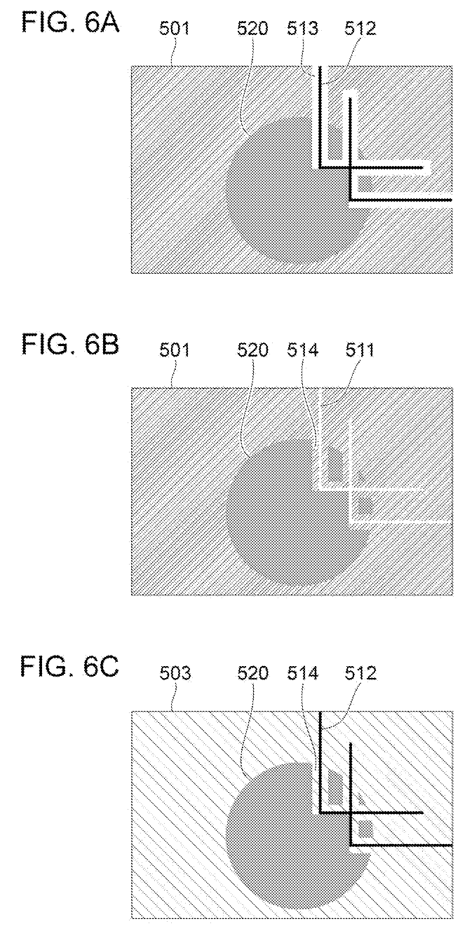

Likewise, a yellow sheet 503, a light blue sheet 504, and a dark blue sheet 505 to be described below may each have a color tone that is regarded by the user or the like as yellow, white, black, light blue, or dark blue in appearance. Likewise, a white mark image 511, a black mark image 512, and a white peripheral image 513 (see FIG. 6A) may each have a color tone that is regarded by the user or the like as yellow, white, black, light blue, or dark blue in appearance.

In FIG. 5A, a process of forming the mark as a white mark image 511 is performed as the process of improving the visibility of the mark. The color tone of the white mark image 511 and the color tone of the black sheet 501 mainly differ from each other in lightness and hue. On the black sheet 501, the visibility of the mark is higher in a case where the mark is formed as a white mark image 511 than in a case where the mark is formed as a black mark image 512. Note that no process is performed on the periphery of the mark.

In FIG. 5B, a process of forming the mark as a black mark image 512 is performed as the process of improving the visibility of the mark. The color tone of the black mark image 512 and the color tone of the white sheet 502 mainly differ from each other in lightness and hue. On the white sheet 502, the visibility of the mark is higher in the case where the mark is formed as a black mark image 512 than in the case where the mark is formed as a white mark image 511. Note that no process is performed on the periphery of the mark.

While FIGS. 5A and 5B each illustrate a case of a sheet having no image other than a mark, the above process is also performed on a mark in a case of a sheet having an image other than a mark, as long as the sheet has a margin for forming a mark. For example, in the case of a sheet having an image other than a mark, as long as there is no overlap between the image other than a mark and the image of the mark, the sheet is regarded as having a margin for forming the mark, so that the above process is performed on the mark.

FIGS. 6A to 6C illustrate a process that is performed on a mark or the periphery of the mark in respective cases of sheets each having no margin for forming the mark. The sheets illustrated in FIGS. 6A to 6C each have a green circular image 520. In the cases illustrated in FIGS. 6A to 6C, the area for forming the mark and the area for forming the circular image 520 overlap each other.

FIG. 6A illustrates a process that is performed in a case where the sheet has a black color and a setting for forming the mark as a black mark image 512 is made. FIG. 6B illustrates a process that is performed on the mark or the periphery of the mark in a case where the sheet has a black color and a setting for forming the mark as a white mark image 511 is made. FIG. 6C illustrates a process that is performed on the mark or the periphery of the mark in a case of a yellow sheet 503. Yellow refers to a color represented by a value related to the color tone of the sheet that is higher than or equal to the predetermined value. The yellow sheet 503 and the black sheet 501 differ from each other in lightness, saturation, and hue but may be the same in any one of lightness, saturation, and hue.

In FIG. 6A, a process of forming a white peripheral image 513 on the periphery of the mark is performed as the process of improving the visibility of the mark for the case where the mark is formed as a black mark image 512. The white peripheral image 513 is formed on both the periphery of a portion of the black mark image 512 that is on the circular image 520 and the periphery of a portion of the black mark image 512 that is not on the circular image 520. The black mark image 512 has a color tone the same as or similar to the color tone of the black sheet 501, whereas the white peripheral image 513 has a different color tone from the black sheet 501. On the black sheet 501 having the black mark image 512, the visibility of the mark is higher with a white peripheral image 513 formed on the periphery of the mark than with no image formed on the periphery of the mark.

In FIG. 6B, a process of withholding the formation of the circular image 520 on the periphery of the white mark image 511 is performed as the process of improving the visibility of the mark for the case where the mark is formed as a white mark image 511. Specifically, at the overlap between the white mark image 511 and the circular image 520, the formation of the circular image 520 is withheld on the area for forming the white mark image 511 and on the periphery of the white mark image 511. This process is not performed on the periphery of a portion of the white mark image 511 that is not on the circular image 520. The white mark image 511 has a different color tone from the black sheet 501, whereas the periphery of the mark has the same color tone as the black sheet 501. On the black sheet 501 having the white mark image 511, the visibility of the mark is higher with the periphery of the mark being in the color tone of the black sheet 501 than with a white peripheral image 513 formed on the periphery of the mark. The case illustrated in FIG. 6B is the same as the case illustrated in FIG. 6A in the color tone of the sheet but is different from the case illustrated in FIG. 6A in the color tone of the mark image. The cases illustrated in FIGS. 6B and 6A are different from each other in the process of improving the visibility of the mark because of the color tone of the mark.

In FIG. 6C, at the overlap between the black mark image 512 and the circular image 520, a process of withholding the formation of the circular image 520 on the periphery of the mark is performed as the process of improving the visibility of the mark for a case where the sheet has a color tone of light yellow. This process is not performed on the periphery of a portion of the black mark image 512 that is not on the circular image 520. The black mark image 512 has a different color tone from the yellow sheet 503, whereas the periphery of the mark has the same color tone as the yellow sheet 503. On the yellow sheet 503 having the black mark image 512, the visibility of the mark is higher with the periphery of the mark being in the color tone of the yellow sheet 503 than with the periphery of the mark being colored in black.

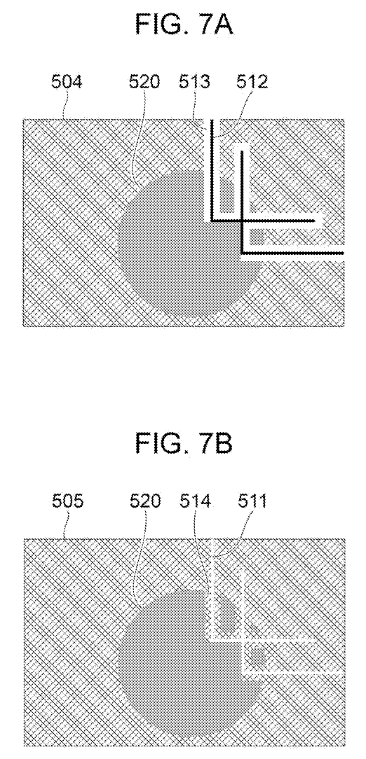

FIGS. 7A and 7B illustrate a process that is performed on a mark or the periphery of the mark in respective cases of sheets having color tones similar to each other and each having no margin for forming the mark. Herein, sheets having color tones similar to each other refer to sheets having color tones that are regarded by the user or the like as belonging to the same group of color tones in appearance. More specifically, sheets having color tones similar to each other refer to sheets having color tones that are similar mainly in the degree of hue. However, if sheets are similar to each other in the degree of at least one of lightness; saturation; and hue, the sheets may be regarded as having color tones similar to each other.

FIG. 7A illustrates a process that is performed in a case where the sheet has a light blue color and the setting for forming the mark as a black mark image 512 is made. FIG. 7B illustrates a process that is performed in a case where the sheet has a dark blue color and the mark is formed as a white mark image 511.

Herein, the light blue sheet 504 and the dark blue sheet 505 are sheets that are regarded by the user or the like as belonging to the same group of blue color tones in appearance. Dark blue and light blue are similar to each other in saturation and hue but are greatly different from each other in lightness. That is, the difference between dark blue and light blue is greater in lightness than in saturation or hue. Not only lightness but also saturation and/or hue may be greatly different.

In FIG. 7A, a process of forming a white peripheral image 513 on the periphery of the mark is performed as the process of improving the visibility of the mark for the case where the mark is formed as a black mark image 512. The white peripheral image 513 is formed on both the periphery of a portion of the black mark image 512 that is on the circular image 520 and the periphery of a portion of the black mark image 512 that is not on the circular image 520. The black mark image 512 has a different color from the light blue sheet 504, and the periphery of the mark has a different color from the light blue sheet 504.

In FIG. 7B, a process of withholding the formation of the circular image 520 on the periphery of the white mark image 511 is performed as the process of improving the visibility of the mark for the case where the mark is formed as a white mark image 511. Specifically, at the overlap between the white mark image 511 and the circular image 520, the formation of the circular image 520 is withheld on the area for forming the white mark image 511 and on the periphery of the white mark image 511. This process is not performed on the periphery of a portion of the white mark image 511 that is not on the circular image 520. The white mark image 511 has a different color from the dark blue sheet 505, whereas the periphery of the mark has the same color as the sheet.

In FIGS. 6A to 6C and FIGS. 7A and 7B, at the overlap between the mark image and the circular image, a portion of the periphery of the mark image is not subjected to the process of improving the visibility of the mark, so that the appearance of the sheet after post-processing is improved. Alternatively, such a portion may be subjected to the process of improving the visibility that has been described with reference to FIGS. 6A to 6C and FIGS. 7A and 7B.

### Appendix

(((1)))

An image forming apparatus comprising:

a processor configured to:

acquire sheet color information that is information on a color tone of a sheet;

acquire image information that is information on an image to be formed on the sheet; and

acquire mark information that is information on a mark indicating a position of the sheet at which a process is to be performed,

wherein a process of improving a visibility of the mark in accordance with the sheet color information is performed on an overlap between the image information and the mark, the overlap being acquired from the image information and the mark information.

(((2)))

The image forming apparatus according to (((1))), wherein the process of improving the visibility of the mark is performing a predetermined process on a periphery of the mark.

(((3)))

The image forming apparatus according to (((2))), wherein the predetermined process is a process of forming an image on the periphery of the mark.

(((4)))

The image forming apparatus according to (((1))), wherein the process of improving the visibility of the mark varies with the color tone of the sheet that is obtained from the sheet color information.

(((5)))

The image forming apparatus according to (((4))), wherein the process of improving the visibility of the mark is a process of forming a white image over an area for forming the mark and the periphery of the area before forming the mark.

(((6)))

The image forming apparatus according to (((5))), wherein the process of forming a white image is performed in a case where the color tone of the sheet is lower than a predetermined value and a setting of forming the mark as a black image is made.

(((7)))

The image forming apparatus according to (((4))), wherein the process of improving the visibility of the mark is a process of controlling formation of the image information to be withheld on the periphery of the mark in a case where the color tone of the sheet is lower than a predetermined value and a setting of forming the mark as an image in a color different from black is made.

(((8)))

The image forming apparatus according to (((4))), wherein the process of improving the visibility of the mark is a process of controlling formation of the image information to be withheld on the periphery of the mark in a case where the color tone of the sheet is higher than or equal to a predetermined value.

(((9)))

The image forming apparatus according to any of (((6))) to (((8))), wherein the predetermined value is a value representing a lightness of the color tone of the sheet.

What is claimed is:

1. An image forming apparatus comprising:
a processor configured to:
acquire sheet color information that is information on a color tone of a sheet;
acquire image information that is information on an image to be formed on the sheet; and
acquire mark information that is information on a mark indicating a position of the sheet,
wherein a process of improving a visibility of the mark in accordance with the sheet color information is performed on an overlap between the image information and the mark, the overlap being acquired from the image information and the mark information.

2. The image forming apparatus according to claim 1, wherein the process of improving the visibility of the mark is performing a predetermined process on a periphery of the mark.

3. The image forming apparatus according to claim 2, wherein the predetermined process is a process of forming an image on the periphery of the mark.

4. The image forming apparatus according to claim 1, wherein the process of improving the visibility of the mark varies with the color tone of the sheet that is obtained from the sheet color information.

5. The image forming apparatus according to claim 4, wherein the process of improving the visibility of the mark is a process of forming a white image over an area for forming the mark and the periphery of the area before forming the mark.

6. The image forming apparatus according to claim 5, wherein the process of forming a white image is performed in a case where the color tone of the sheet is lower than a predetermined value and a setting of forming the mark as a black image is made.

7. The image forming apparatus according to claim 4, wherein the process of improving the visibility of the mark is a process of controlling formation of the image information to be withheld on the periphery of the mark in a case where the color tone of the sheet is lower than a predetermined value and a setting of forming the mark as an image in a color different from black is made.

8. The image forming apparatus according to claim 4, wherein the process of improving the visibility of the mark is a process of controlling formation of the image information to be withheld on the periphery of the mark in a case where the color tone of the sheet is higher than or equal to a predetermined value.

9. The image forming apparatus according to claim 6, wherein the predetermined value is a value representing a lightness of the color tone of the sheet.

10. The image forming apparatus according to claim 7, wherein the predetermined value is a value representing a lightness of the color tone of the sheet.

11. The image forming apparatus according to claim 8, wherein the predetermined value is a value representing a lightness of the color tone of the sheet.
